(19) United States
(12) Patent Application Publication
(10) Pub. No.: US 2016/0356165 A1
(43) Pub. Date: Dec. 8, 2016

(54) Abrasive Tip Blade Manufacture Methods

(71) Applicant: UNITED TECHNOLOGIES CORPORATION, Hartford, CT (US)

(72) Inventors: Christopher W. STROCK, Kennebunk, ME (US); Russell A. BEERS, Manchester, CT (US); James O. HANSEN, Glastonbury, CT (US); Thomas J. GAROSSHEN, Glastonbury, CT (US)

(73) Assignee: United Technologies Corporation, Farmington, CT (US)

(21) Appl. No.: 15/118,934

(22) PCT Filed: Feb. 11, 2015
(86) PCT No.: PCT/US2015/015381

§ 371 Date: Aug. 15, 2016

Related U.S. Application Data
(60) Provisional application No. 61/939,904, filed on Feb. 14, 2014.

(51) Int. Cl. F01D 5/28; F04D 29/32; F04D 29/38; F04D 29/52; C23C 4/01; C23C 4/06; C23C 4/11; C23C 4/134; C23C 4/131; C23C 4/18; F01D 5/02; F01D 25/24

(52) U.S. Cl. CPC F01D 5/288; F01D 5/02; F04D 29/325; F04D 29/388; F04D 29/526; F01D 25/24; C23C 4/06; C23C 4/11; C23C 4/134; C23C 4/131; C23C 4/18; C23C 4/01; F05D 2220/32; F05D 2230/312; F05D 2230/311; F05D 2230/90; F05D 2300/6032; F05D 2300/21

(57) ABSTRACT

In a method for manufacturing a blade, the blade comprises: an airfoil (100) having a root end and a tip (106); a metallic substrate (102) along at least a portion of the airfoil; and a tip coating (152) comprising an oxide abrasive (156) and an aluminum-based matrix (154). The method comprises simultaneous thermal spray of the matrix and the abrasive.

### CROSS REFERENCE TO RELATED APPLICATION

Benefit is claimed of U.S. Patent Application No. 61/939,904, filed Feb. 14, 2014, and entitled “Abrasive Tip Blade Manufacture Methods”, the disclosure of which is incorporated by reference herein in its entirety as if set forth at length.

### BACKGROUND

The disclosure relates to blades and rub coatings. More particularly, the disclosure relates to abrasive blade tips for cooperating with abradable coatings on turbomachines such as gas turbine engines.

Abradable coatings (rub coatings) protect moving parts from damage during rub interaction and wear to establish a mating surface to the moving parts with smallest possible clearance. The coatings are used in turbomachines to interface with the tips of a rotating blade stage, tips of cantilevered vanes and knife edge seals.

In an exemplary turbomachine such as a gas turbine engine, more particularly, a turbofan engine, coatings may be used to interface with the blade tips of fan blade stages, compressor blade stages, and turbine blade stages. Because temperature generally increases through the fan and compressor and is yet much higher in the turbine, different blade materials, surrounding case materials, and coating materials may be desired at different locations along the engine.

With relatively low temperatures in the fan and compressor sections, relatively low temperature materials may be used for their blades and the surrounding cases (at least through upstream (lower pressure) portions of the compressor). The exemplary blade materials in such lower temperature stages may be aluminum alloy, titanium alloy, carbon fiber or other composite, combinations thereof, and the like. Similarly, relatively lower temperature case materials may be provided. Particularly because the case material is not subject to the centrifugal loading that blades are, even lower temperature capability materials may be used (e.g., aramid or other fiber composites) in the case than in the blades.

US Patent Application Publication 20130156588 A1, published Jun. 20, 2013, and entitled “Electrical grounding for fan blades”, discloses blades having polyurethane-coated aluminum substrates.

It is known to use a coating along the inboard or inner diameter (ID) surface of the case component to interface with the blade tips. Such coatings serve to protect blade tips from damage during rub contact between the blades and case. When the blade tips are protected from damage during rub, clearance between the blades and case ID can be set closer and tighter operating clearance can be achieved.

To limit blade damage, the adjacent surfaces of the surrounding shroud may be formed by an abradable rub coating. Examples of abradable rub coatings are found in U.S. Pat. Nos. 3,575,427, 6,334,617, and 8,020,875. One exemplary baseline coating comprises a silicone matrix with glass micro-balloon filler. Without the glass filler, the elastic properties of the abradable coating result in vibrational resonances and non-uniform rub response. The glass increases the effective modulus of the coating so as to reduce deformation associated with aerodynamic forces and resonances. More recent proposals include filler such as polymer micro-balloons (PCT/US2013/023570) and carbon nanotubes (PCT/US2013/023566).

For interfacing with the abradable rub coating, the blade tips may bear an abrasive coating. US Patent Application Publication 2013/0004328 A1, published Jan. 3, 2013, and entitled “ABRASIVE AIRFOIL TIP” discloses a number of such coatings.

### SUMMARY

One aspect of the disclosure involves a method for manufacturing a blade. The blade comprises: an airfoil having a root end and a tip; a metallic substrate along at least a portion of the airfoil; and a tip coating comprising an oxide abrasive and an aluminum-based matrix. The method comprises simultaneous thermal spray of the matrix and the abrasive.

A further embodiment may additionally and/or alternatively include the coating having a content of the oxide of at least twenty volume percent, more particularly twenty to fifty volume percent.

A further embodiment may additionally and/or alternatively include the oxide comprising at least 50 weight percent of alumina or zirconia or a combination thereof.

A further embodiment may additionally and/or alternatively include: the matrix being at least 75 weight percent aluminum; and the oxide filling the matrix to at least 20 volume percent.

A further embodiment may additionally and/or alternatively include the tip coating having a characteristic thickness of 0.1 mm to 0.3 mm.

A further embodiment may additionally and/or alternatively include the abrasive having a characteristic size of 3 micrometers to 25 micrometers.

A further embodiment may additionally and/or alternatively include a blade manufactured according to the method.

A further embodiment may additionally and/or alternatively include a rotor comprising a circumferential array of the blades.

A further embodiment may additionally and/or alternatively include gas turbine engine comprising the rotor and a case encircling the rotor. The case has a substrate and a coating on an inner surface of the substrate facing the rotor.

A further embodiment may additionally and/or alternatively include causing the tip coating to abrade an adjacent coating.

A further embodiment may additionally and/or alternatively include the simultaneous thermal spraying comprising simultaneous plasma spraying.

A further embodiment may additionally and/or alternatively include the simultaneous thermal spraying comprising using a single spray gun to simultaneously apply the matrix from a first source and the abrasive from a second source.

A further embodiment may additionally and/or alternatively include the first source being a source of at least 50% by weight powder of at least 80% by weight aluminum and the second source being a source of at least 50% by weight powder of at least 50% by weight aluminum oxide.

A further embodiment may additionally and/or alternatively include the simultaneous plasma spraying comprising melting a wire having an oxide core.

A further embodiment may additionally and/or alternatively include the simultaneous plasma spraying comprising a twin wire arc spraying.

A further embodiment may additionally and/or alternatively include the tip being shadow masked during the spraying.

A further embodiment may additionally and/or alternatively include applying a polymeric coating to a pressure side and a suction side of the airfoil.

A further embodiment may additionally and/or alternatively include the simultaneous thermal spraying comprising using one or more sources of metallic powder and, in-flight, oxidizing a portion of the portion of the powder to from the oxide.

A further embodiment may additionally and/or alternatively include the one or more sources comprising a first powder source being of powder having a first size distribution and a second powder source of powder having a second size distribution smaller than the first size distribution.

A further embodiment may additionally and/or alternatively include the aluminum-based matrix comprising by weight 1.0-7.5 percent Zn or 2.0-5.0 percent Zn or 4.0-6.0 percent Zn.

A further embodiment may additionally and/or alternatively include the aluminum-based matrix comprising by weight one to all of: 0.05-0.20 Si; and 0.010-0.40 percent combined one-to all of In, Sn, Cd, Ga, Hg.

Another aspect of the disclosure involves a blade comprising: an airfoil having a root end and a tip; a metallic substrate along at least a portion of the airfoil; and a tip coating comprising an abrasive and an aluminum based matrix. The aluminum-based matrix comprises, by weight, 1.0-7.50 percent Zn.

A further embodiment may additionally and/or alternatively include the matrix comprising, by weight, 0.010-0.030 percent In.

A further embodiment may additionally and/or alternatively include the aluminum-based matrix comprising by weight one to all of: 0.05-0.20 Si; and 0.010-0.40 percent combined one-to all of In, Sn, Cd, Ga, Hg.

A further embodiment may additionally and/or alternatively include the matrix comprising, by weight: balance Al; 4.75-5.75 percent Zn; 0.016-0.020 percent In; 0.20 max. each other element; and 0.50 max. total other elements.

Another aspect of the disclosure involves a blade comprising: an airfoil having a root end and a tip; a metallic substrate along at least a portion of the airfoil; and a tip coating comprising an abrasive and an aluminum based matrix. The aluminum-based matrix is at least 275 millivolts more active than the metallic substrate.

A further embodiment may additionally and/or alternatively include the metallic substrate being aluminum-based.

The details of one or more embodiments are set forth in the accompanying drawings and the description below. Other features, objects, and advantages will be apparent from the description and drawings, and from the claims.

### BRIEF DESCRIPTION OF THE DRAWINGS

FIG. 1 is a partially schematic half-sectional view of a turbofan engine.

FIG. 2 is an enlarged transverse cutaway view of a fan blade tip region of the engine of FIG. 1 taken along line 2-2 and showing a first rub coating.

FIG. 2A is an enlarged view of a blade tip region of

FIG. 2.

FIG. 3 is a view of a powder spray apparatus depositing an abrasive tip coating.

FIG. 4 is a view of a twin-wire spray apparatus depositing an abrasive tip coating.

FIG. 5 is a sectional view of the blade with a first mask.

FIG. 6 is a sectional view of the blade with a second mask.

FIG. 7 is a sectional view of the blade with a third mask.

Like reference numbers and designations in the various drawings indicate like elements.

### DETAILED DESCRIPTION

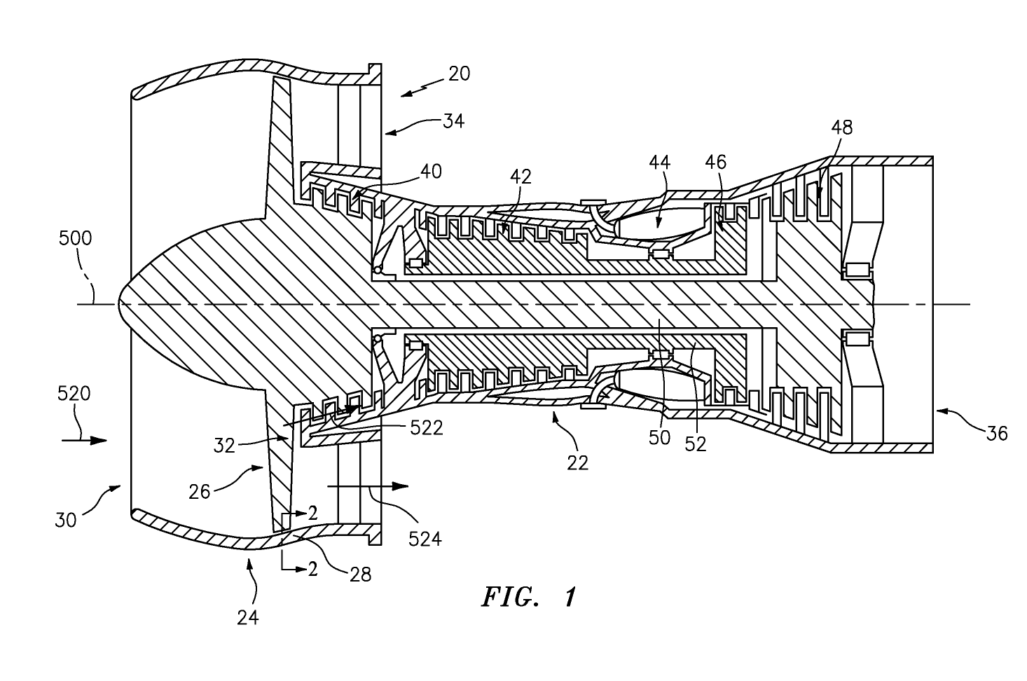

FIG. 1 shows a gas turbine engine 20 having an engine case 22 surrounding a centerline or central longitudinal axis 500. An exemplary gas turbine engine is a turbofan engine having a fan section 24 including a fan 26 within a fan case 28. The exemplary engine includes an inlet 30 at an upstream end of the fan case receiving an inlet flow along an inlet flowpath 520. The fan 26 has one or more stages 32 of fan blades. Downstream of the fan blades, the flowpath 520 splits into an inboard portion 522 being a core flowpath and passing through a core of the engine and an outboard portion 524 being a bypass flowpath exiting an outlet 34 of the fan case.

The core flowpath 522 proceeds downstream to an engine outlet 36 through one or more compressor sections, a combustor, and one or more turbine sections. The exemplary engine has two axial compressor sections and two axial turbine sections, although other configurations are equally applicable. From upstream to downstream there is a low pressure compressor section (LPC) 40, a high pressure compressor section (HPC) 42, a combustor section 44, a high pressure turbine section (HPT) 46, and a low pressure turbine section (LPT) 48. Each of the LPC, HPC, HPT, and LPT comprises one or more stages of blades which may be interspersed with one or more stages of stator vanes.

In the exemplary engine, the blade stages of the LPC and LPT are part of a low pressure spool mounted for rotation about the axis 500. The exemplary low pressure spool includes a shaft (low pressure shaft) 50 which couples the blade stages of the LPT to those of the LPC and allows the LPT to drive rotation of the LPC. In the exemplary engine, the shaft 50 also drives the fan. In the exemplary implementation, the fan is driven via a transmission (not shown, e.g., a fan gear drive system such as an epicyclic transmission) to allow the fan to rotate at a lower speed than the low pressure shaft.

The exemplary engine further includes a high pressure shaft 52 mounted for rotation about the axis 500 and coupling the blade stages of the HPT to those of the HPC to allow the HPT to drive rotation of the HPC. In the combustor 44, fuel is introduced to compressed air from the HPC and combusted to produce a high pressure gas which, in turn, is expanded in the turbine sections to extract energy and drive rotation of the respective turbine sections and their associated compressor sections (to provide the compressed air to the combustor) and fan.

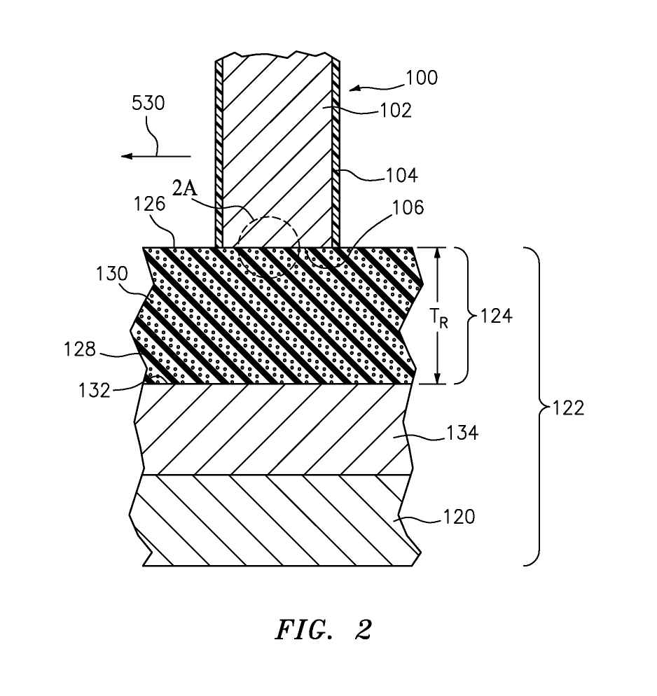

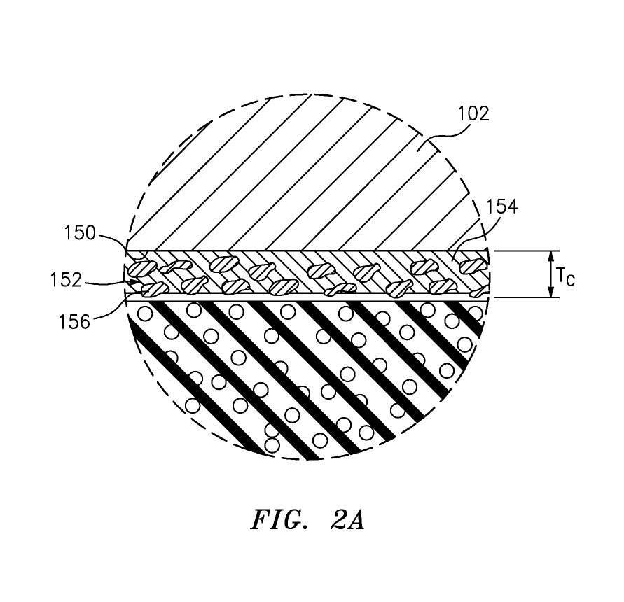

FIG. 2 shows a cutaway blade 100 showing a blade substrate (e.g., an aluminum alloy) 102 and a polymeric coating 104 (e.g., a polyurethane-based coating) on the substrate. The exemplary coating is along pressure and suction sides and spans the entire lateral surface of the blade between the leading edge and trailing edge. The exemplary coating, however, is not on the blade tip 106. If originally applied to the tip, the coating may have been essentially worn off during rub. Circumferential movement in a direction 530 is schematically shown.

FIG. 2 also shows an overall structure of the fan case facing the blade. This may include, in at least one example, a structural case 120. It may also include a multi-layer liner assembly 122. An inboard layer of the liner assembly may be formed by a rub material 124. The exemplary rub material 124 has an inboard/inner diameter (ID) surface 126 facing the blade tips and positioned to potentially rub with such tips during transient or other conditions.

The exemplary rub material 124 comprises a polymeric matrix material 128 and a filler 130 (e.g., polymeric particles or micro-balloons or glass micro-balloons). The exemplary rub material may be formed as a coating on an ID surface 132 of a substrate 134 of the liner assembly. An exemplary substrate 134 is titanium alloy AMS 4911. The rub material is shown as having an overall thickness T_{R}. Exemplary T_{R} is 1-10 mm, more particularly, 3-6 mm. Alternative abradable rub material may include metal matrix composites (e.g., formed by thermal spray coating).

FIG. 2A shows the tip region 106 with a tip surface 150 of the substrate bearing a coating 152. The coating 152 comprises matrix 154 and abrasive 156. The coating has a thickness T_{C}. Exemplary T_{C} is 2-35 mils (50 micrometers to 0.9 mm), more particularly, 4-12 mils (0.1 mm to 0.3 mm).

Exemplary matrix material is aluminum or aluminum alloy. One exemplary alloy is 88-12 Al—Si. Other matrix alloys for galvanic protection of the substrate are discussed below. Exemplary abrasive is alumina and/or zirconia or alumina-based and/or zirconia-based (e.g., at least 50% alumina and/or zirconia by weight or alumina or zirconia as a largest by-weight component). A particular abrasive is Metco 105NS from Sulzer Metco (US) Inc. Westbury, N.Y. A characteristic particle size and morphology is 15-45 mil (0.38 mm to 1.1 mm) 98 wt % pure alumina particles produced by fusing and crushing.

An exemplary manufacture process involves forming the blade substrate by conventional means (e.g., forging and/or machining and peening). Portions of the blade may be masked. For example, some blade configurations have a titanium leading edge separated from an aluminum substrate by a slight gap (e.g., epoxy-filled for galvanic isolation). The tip surface of the titanium leading edge member and the gap may be masked so that the abrasive coating does not electrically bridge the aluminum substrate and titanium leading edge.

Exemplary masking methods may include silicone thermal spray masking tape in combination with a sheet of rubber to cover the majority of the part. Masking may additionally or alternatively include shadow masking where the shadow mask is spaced apart from the tip. In shadow masking, the gun may be traversed relative to the part. During a portion of the traversal, the mask partially occludes a portion of the deposition area leading to a relatively thick coating in the center of the area, thinning toward the periphery.

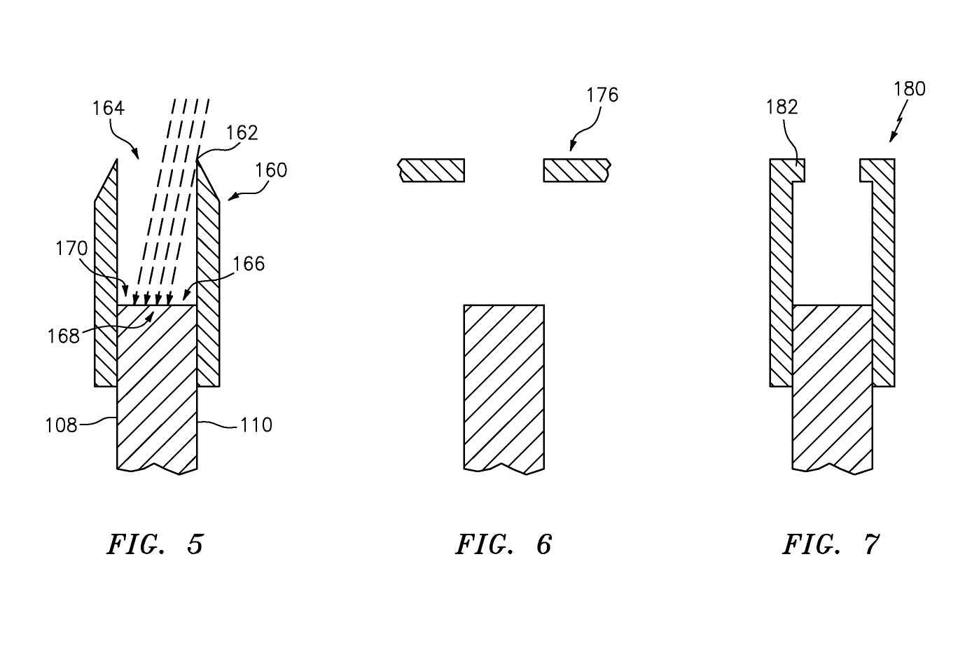

FIG. 5 is a sectional view showing a mask 160 protruding from the tip along pressure side surface 108 and suction side surface 110 of the blade and extending to a rim 162 defining the window or aperture 164. As the spray gun traverses off center, a shadow is initially cast along a peripheral portion 166, while the center 168 and opposite peripheral portion 170 receive coating. The shadow eventually may cover the central portion then the opposite peripheral portion. The spray may approach the window from off center via an opposite process from that side or the other.

FIG. 6 shows a remote non-contact mask 176 where both the window and remainder of the mask are spaced apart from the part (e.g., the mask is a flat plate). The window planform may be slightly greater, the same as, or slightly smaller than the planform area to be coated and may have similar shape thereto. The exemplary externally beveled sharp edge of the mask helps deflect overspray and reduces outward buildup to facilitate reuse.

As an example of a small window, FIG. 7 shows a contact mask 180 having a narrowed window open to a central portion of the region to be coated but with a portion 182 of the mask surround the window directly in front of a perimeter portion of that region so as to more significantly feather the coating along that perimeter portion.

For blades having polymer coatings on the airfoil pressure and suction side surfaces, such coating could also be used to mask if the polymer coating was applied before rather than after applying the abrasive coating.

Thereafter the abrasive coating is then applied by codeposition. An exemplary codeposition involves simultaneous thermal (e.g., air plasma) spray of aluminum powder (for the matrix) and alumina (for the abrasive). Exemplary codepostion involves a system 200 (FIG. 3) with a single plasma gun 202 (having a plasma gas source 201) and separate powder sources 204A, 204B (e.g., powder feeders with separate injection nozzles 206A, 206B coupled to carrier gas sources 207A, 207B) for introducing streams of matrix 208 and abrasive material 210 to the plasma 212. During the spray process, the aluminum and aluminum oxide particles are at least partially melted.

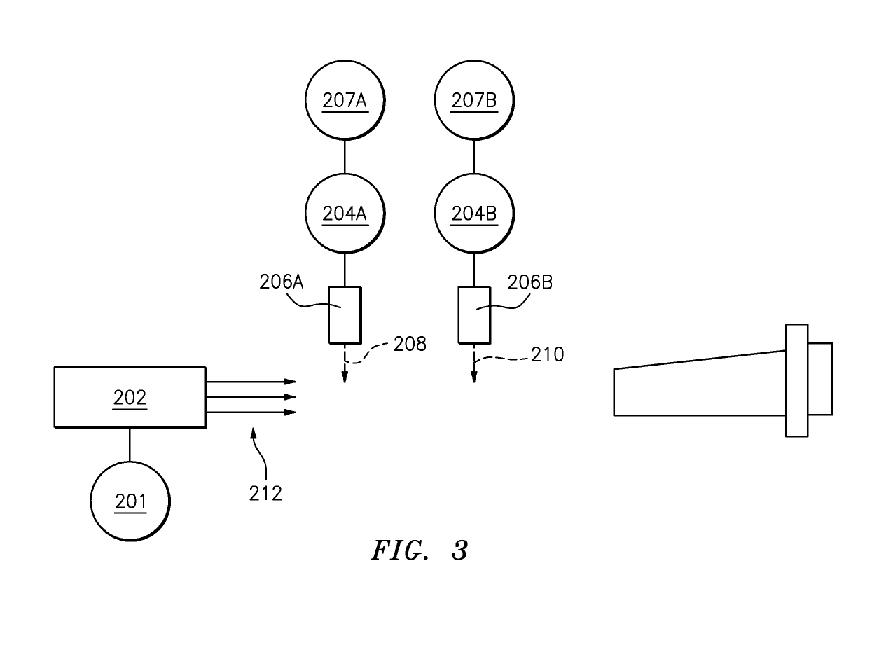

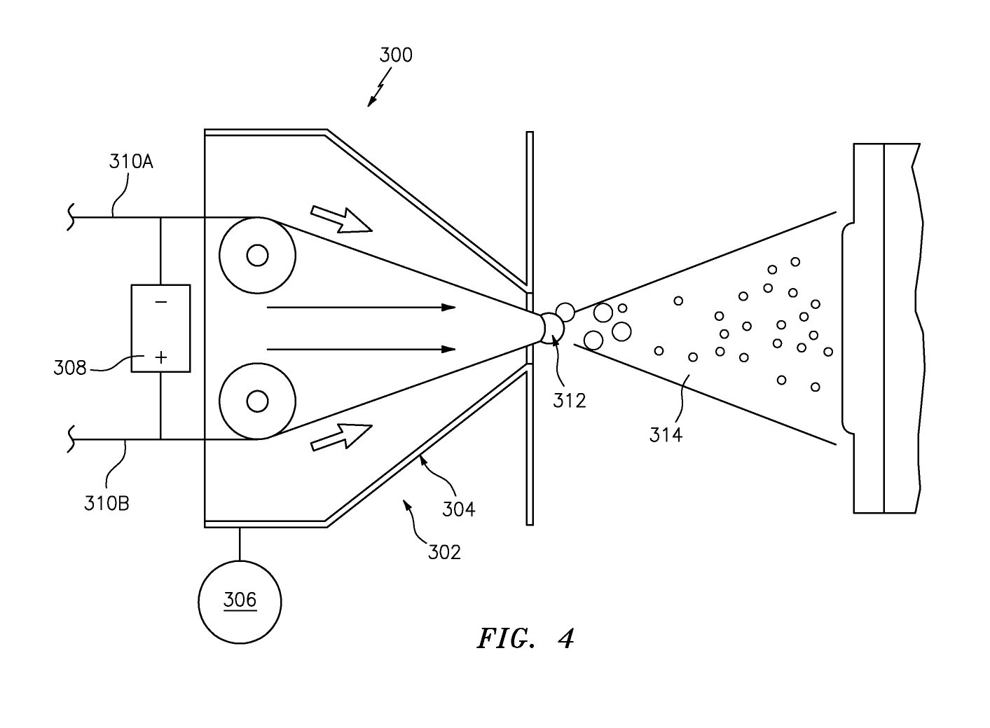

An alternative codeposition process is a twin wire arc spray processes wherein alumina-cored aluminum wire is heated and melted by an electric arc and propelled as droplets (e.g., distinct droplets of alumina and aluminum) toward a surface by a gas stream. FIG. 4 shows an exemplary twin wire system 300 wherein the gun 302 has a nozzle 304 and an atomizing gas supply 306. A power supply 308 applies a voltage between wires 310A and 310B which converge to form an arc 312 and discharge a droplet spray 314 toward the substrate. The exemplary wires are both alumina-cored aluminum. An exemplary volume fraction of alumina in the wires is at least 10%, more particularly, 20-50% or 30-50%. This leads to a similar volume percentage of the as-deposited material. The powder sources of the system 200 may dispense powder in a similar ratio to yield a similar ratio in the coating.

Another alternative deposition process is a twin wire arc spray processes wherein an aluminum (e.g., pure aluminum) wire is heated and melted by an electric arc and propelled as droplets toward a surface by a gas stream. Through interaction with atmospheric oxygen or oxygen as a component of the atomizing gas stream, a portion of the aluminum is oxidized to form aluminum oxide during the spray process. Air may be used as the gas stream to provide the atomization, propulsion, and oxygen. In flight from the nozzle, a surface layer of each droplet will oxidize. The surface layer may have a thickness up to the full particle radius. The oxide surface layer may be molten, partially molten, or solid. Additionally, a fraction of the aluminum droplets may fully or partially solidify during flight. Upon impact with a surface, the droplets flatten and are quench cooled by thermal conduction to the already-deposited coating or substrate. During this process, liquid aluminum and liquid aluminum oxide form irregularly shaped laminar or globular features in the coating. Solid or semi-solid (partially molten) particles show less deformation upon impact, may fracture, or deposit as spherical particles. Particle deposition in thermal spray is a highly stochastic process. This leads to the formation of a variety of oxide geometries in the coating ranging from thin stringers to round particles, clusters of oxides, and angular fractured particles. As-deposited volume proportions of oxide and metal may be as discussed above.

Another alternative deposition process is air plasma spray wherein pure aluminum powder is heated and melted by a plasma stream and propelled as droplets toward a surface during which the powder at least partially oxidizes to form the abrasive phase of the coating. Exemplary feed stock powder is Metco 54NS from Sulzer Metco (US) Inc. of Westbury, N.Y. Oxidation occurs by interaction with atmospheric oxygen or oxygen as a component of the powder carrier gas stream. The alumina content of the coating can be manipulated by adjusting feed stock particle size. One or more exemplary ranges of particle size may be selected within a broader range such as 11 micrometers to 150 micrometers. Finer particles have higher relative surface area and reach higher temperature during spray. These will both result in higher alumina fraction in the coating. Additionally, the amount of available oxygen, plasma power and other spray parameters may be adjusted for the purpose of targeting a desired alumina fraction. When using powder feed stock, as opposed to the wire in wire arc spray, a higher level of microstructural control may be achieved. For example, particle size distribution can be tailored to achieve the desired abrasive to matrix ratio in the coating. An example of particle size distribution is a bimodal size distribution. The fine and coarse size fractions are injected to the plasma stream through separate feed systems and powder ports in order to optimize particle heating and trajectory. With separate feed systems, the ratio of fine to coarse powder may be adjusted to target the desired coating properties. The fine powder will form a disproportionate fraction of the oxide while the coarse powder forms a disproportionate fraction of the metal matrix.

An example of a process uses a Sulzer Metco 3 MB spray torch with #708 nozzle operating at 30 kW with pure nitrogen plasma gas flowing at 80 SCFH. Powder feed is 25 g/minute of 10-25 micron particle size through a smaller (e.g., #2) powder port and 45 g/minute of 45 to 100 micron particle size through a larger (e.g., #4) powder port. Both powders are fed using 10 SCFH of air as carrier gas. This oxygen containing carrier gas contributes to the available oxygen in the spray plume for converting aluminum to aluminum oxide.

Further adjustment of oxide content can be achieved by varying the amount of oxygen entrained in the spray plume by using additional gas injector ports such as a #2 powder port (without powder) or adjusting the oxygen fraction in the carrier gas. The additional gas injection and the carrier gas oxygen content may be adjusted from pure nitrogen or other non-oxygen containing gas to pure oxygen. Additionally, water may be injected as liquid or vapor as an oxygen source in the various embodiments.

Relative to uncoated tips or alternative coatings the exemplary coating may have one or more of several advantages. The aluminum based (e.g., pure aluminum) matrix on aluminum substrate combination may have good electrochemical compatibility from an aqueous corrosion perspective.

The aluminum-based matrix is relatively low modulus so that it causes less of a fatigue debit (as opposed to a high modulus coating which at a coating defect or edge will cause a relatively higher stress concentration in the substrate and therefore create a more likely initiation site for cracking), is soft and has a low melting point so that it wears away at relatively lower surface temperature during rub (e.g., rub with a glass filled abradable case liner or blade outer air seal coating).

Melting point limits the maximum temperature that can be caused by frictional heating. Low melting point of aluminum (compared with prior art nickel matrix), means that there is significant softening as the contact surface heats up, thereby reducing forces and heat generation compared with the nickel.

In wearing away, it further reduces rub temperature by exposing hard alumina abrasive phase. Aluminum properties of the substrate are very temperature sensitive. The spray process using aluminum matrix can keep the part temperature low (e.g., potentially as low as 200° F. (93° C.)) and not harm the base metal properties.

In general, exemplary particle size is 0.5 micrometer to 50 micrometers. More particularly, a characteristic size (mean, median, or modal from the volume point of view) is 3 micrometers to 25 micrometers or 3 micrometers to 10 micrometers. Exemplary size is measured in as the least dimension (e.g., the minor axis of an ellipsoid).

As an alternative to pure aluminum matrix material, aluminum alloys may be used as noted above. One possible use of aluminum alloy matrix is to use the matrix as a sacrificial anode relative to substrate material. Candidate matrix materials may be based on compositions used for galvanic protection of aluminum-hulled ships. Such protection as a blade coating has been proposed in PCT/US14/17701, published Sep. 25, 2014 as WO2014/149365 A1.

Table I below shows exemplary compositions:

TABLE I
Matrix Alloys for Substrate Galvanic Protection (Weight %)

| | Alloy | | | | | | | | |
|---|---|---|---|---|---|---|---|---|---|
| | Galvotec | | | | | | | | |
| Element | CW III* | Ex. 1 | Ex. 2 | Ex. 3 | Ex. 4 | Ex. 5 | Ex 6 | Ex 7 | Ex 8 |
| Zn | 4.75-5.75 | 1.0 to 7.5 | 1.0 to 7.5 | 1.0 to 7.5 | 1.0 to 7.5 | 1.0 to 7.5 | 1.0 to 7.5 | 2.0 to 7.0 | 2.0 to 5.0 |
| In, Sn, | 0.016-0.020 | 0.010 to | 0.050 to | 0.020 to | 0.01 to | 0.01 to | 0.01 to | 0.01 to | 0.01 to |
| Cd, Ga, | In | 0.20 In | 0.30 Sn | 0.050 Cd | 0.10 Ga | 0.10 hg | 0.40 | 0.4 | 0.30 |
| Hg | | | | | | | combined | combined | combined |
| Si | 0.080-0.12 | 0.20 max | 0.20 max | 0.20 max | 0.20 max | 0.20 max | 0.20 max | 0.20 max | 0.20 max |
| Cu | 0.003 | 0.10 max | 0.10 max | 0.10 max | 0.10 max | 0.10 max | 0.10 max | 0.10 max | 0.10 max |
| | max. | | | | | | | | |
| Fe | 0.060 | 0.10 max | 0.10 max | 0.10 max | 0.10 max | 0.10 max | 0.10 max | 0.10 max | 0.10 max |
| | max. | | | | | | | | |
| Al | Bal. | Bal. | Bal. | Bal. | Bal. | Bal. | Bal. | Bal. | Bal. |

*Trademark of Galvotec Alloys, Inc., Harvey, Louisiana.

For each of the ranges with 0.20 max Si, 0.10 max Cu, and 0.10 max Fe, one to all of these ranges may be narrowed to respective values of 0.15 max Si, 0.010 max Cu, and 0.060 max Fe. An alternative Zn content for Ex. 7 or 8 would be 4.0 to 6.0 weight percent.

The Zn provides the principal effect on galvanic potential relative to Al. Thus, exemplary alloys may comprise the Al and Zn. Zn content may be selected to keep the matrix anodic to the substrate, thus, higher Zn in the substrate will likely be associated with higher Zn in the matrix.

The In, Sn, Cd, Ga, and/or Hg tend to hinder the protective self-oxidation of the basic Al—Zn mixture to assist in ability to sacrifice.

Si, if present, may help control microstructure. Thus, variations on the examples above where only a max Si is specified could include a min Si of 0.050 weigh percent.

Other elements beyond the Al and Zr may be present in standard impurity levels or at non-impurity levels that do not substantially compromise galvanic protection (e.g., that do not reduce the difference in potential relative to the substrate by more than 50% compared with the basic potential associated with the Al—Zr combination in the ratio present in that matrix). Exemplary other elements would be expected to aggregate not more than 5.0 weight percent or 3.0 weight percent or 1.0 weight percent and would typically be present individually at not more than 1.5 weight percent or 1.0 weight percent.

Exemplary substrate alloys include 2000-series and 7000-series high stress aluminum alloys. Exemplary alloys are at least 80.0 weight percent Al, more particularly at least 85.0, with an exemplary 85.0-96.0. Table II below shows exemplary compositions:

TABLE II
Substrate Alloys Subject to Galvanic Protection (Weight %)

| | Alloy | | | | |
|---|---|---|---|---|---|
| Element | AA7255 | AA2060 | AA2099 | Range 1 | Range 2 |
| Al | Remainder | Remainder | Remainder | Remainder | Remainder |
| Cr | <=0.04 | | <=0.05 | <=0.05 | <=0.3 |
| Cu | 2.0-2.6 | 3.4-4.5 | 2.4-3.0 | 2.0-4.5 | 1.0-4.5 |
| Fe | <=0.09 | <=0.07 | <=0.07 | <=0.09 | <=0.15 |
| Li | | 0.60-0.90 | −2.0 | <=2.0 | <=3.0 |
| Mg | 1.8-2.3 | 0.60-1.1 | 0.1-0.5 | 0.1-2.3 | 0.05-3.0 |
| Mn | 0.05 | 0.10-0.50 | 0.1-0.5 | 0.10-0.50 | <=0.6 |
| Other, | <=0.05 | <=0.05 | <=0.05 | <=0.05 | <=0.05 |
| (each) | | | | | |
| Other, | <=0.15 | <=0.15 | <=0.15 | <=0.15 | <=0.15 |
| (total) | | | | | |
| Si | <=0.06 | <=0.07 | <=0.05 | <=0.07 | <=0.4 |
| Ag | | 0.05-0.50 | | <=0.50 | <=1.0 |
| Ti | <=0.06 | <=0.10 | <=0.10 | <=0.10 | <=0.25 |
| Zn | 7.6-8.4 | 0.30-0.50 | 0.40-1.0 | 0.3-8.4 | 0.1-10.0 |
| Zr | 0.08-0.15 | 0.05-0.15 | 0.05-0.12 | 0.05-0.15 | <=0.25 |

Additional substrate candidates include developmental alloys containing additional components such as Sc, Co, and Y.

For application techniques, similar techniques to those mentioned above may be used as may similar abrasives. Additional abrasives may also be used including but not limited to carbides (e.g., titanium carbide), borides (e.g., titanium boride) nitrides (e.g., titanium nitride), diamond like carbon, quartz, and the like. Other spray techniques may also be utilized.

The as-deposited matrix, may have the same composition as the source matrix material (e.g., of Table I) at least away from very slight diffusion zones around the abrasive particles (e.g., carbides and borides as abrasives will have relatively low reactivity or diffusion with the matrix).

To provide desirable protection, exemplary matrix alloys are sufficiently more anodic than the substrates they protect. One measurement is standard electrode potential by which the matrix alloys may be at least 300 millivolt more active than the substrate alloys they protect, more broadly at least 275 millivolts. An exemplary range is 100 millivolts to 400 millivolts, more narrowly 275 millivolts to 325 millivolts.

The use of “first”, “second”, and the like in the following claims is for differentiation within the claim only and does not necessarily indicate relative or absolute importance or temporal order. Similarly, the identification in a claim of one element as “first” (or the like) does not preclude such “first” element from identifying an element that is referred to as “second” (or the like) in another claim or in the description.

Where a measure is given in English units followed by a parenthetical containing SI or other units, the parenthetical's units are a conversion and should not imply a degree of precision not found in the English units.

One or more embodiments have been described. Nevertheless, it will be understood that various modifications may be made. For example, when applied to an existing baseline configuration, details of such baseline may influence details of particular implementations. Accordingly, other embodiments are within the scope of the following claims.

1. A method for manufacturing a blade, the blade comprising:
an airfoil (100) having:
a root end and a tip (106);
a metallic substrate (102) along at least a portion of the airfoil; and
a tip coating (152) comprising an oxide abrasive (156) and an aluminum-based matrix (154), the method comprising:
simultaneous thermal spraying of the matrix and the abrasive.

2. The method of claim 1 wherein:
the oxide comprises at least 50 weight percent of alumina or zirconia or a combination thereof.

3. The method of claim 1 wherein the aluminum-based matrix comprises, by weight, 1.0-7.5 percent Zn.

4. The method of claim 1 wherein the aluminum-based matrix is at least 275 millivolts more active than the metallic substrate.

5. The method of claim 1 wherein:
the tip coating has a content of the oxide of at least twenty volume percent.

6. The method of claim 1 wherein:
the tip coating has a content of the oxide of at twenty volume percent to fifty volume percent.

7. The method of claim 1 wherein:
the matrix is at least 75 weight percent aluminum; and
the oxide fills the matrix to at least 20 volume percent.

8. The method of claim 1 wherein:
the tip coating has a characteristic thickness of 0.1 mm to 0.3 mm.

9. The method of claim 1 wherein:
the abrasive has a characteristic size of 3 micrometers to 25 micrometers.

10. The method of claim 1 wherein:
the simultaneous thermal spraying comprises using one or more sources of metallic powder and, in-flight, oxidizing a portion of the powder to form the oxide.

11. The method of claim 10 wherein:
the one or more sources comprise a first powder source being of powder having a first size distribution and a second powder source of powder having a second size distribution smaller than the first size distribution.

12. The method of claim 1 wherein:
the simultaneous thermal spraying comprises simultaneous plasma spraying.

13. The method of claim 12 wherein:
the simultaneous plasma spraying comprises using a single plasma gun to simultaneously apply the matrix from a first source and the abrasive from a second source.

14. The method of claim 13 wherein:
the first source is a source of at least 50% by weight powder of at least 80% by weight aluminum; and
the second source is a source of at least 50% by weight powder of at least 50% by weight aluminum oxide.

15. The method of claim 13 wherein:
the simultaneous plasma spraying comprises melting a wire having a metallic outer layer as the first source and an oxide core as the second source.

16. The method of claim 13 wherein:
the simultaneous plasma spraying comprises a twin wire arc spraying.

17. The method of claim 1 wherein:
the tip is shadow masked during the spraying.

18. The method of claim 1 further comprising:
applying a polymeric coating to a pressure side and a suction side of the airfoil.

19. A blade manufactured according to the method of claim 1.

20. The blade of claim 19 wherein the aluminum-based matrix comprises by weight:
1.0-7.5 percent Zn.

21. The blade of claim 20 wherein the aluminum-based matrix comprises by weight:
2.0-5.0 percent Zn.

22. The blade of claim 20 wherein the aluminum-based matrix comprises by weight:
4.0-6.0 percent Zn.

23. The blade of claim 20 wherein the aluminum-based matrix comprises by weight one to all of:
0.05-0.20 Si; and
0.010-0.40 percent combined one-to all of In, Sn, Cd, Ga, Hg.

24. A rotor comprising a circumferential array of blades of claim 19.

25. A gas turbine engine comprising:
the rotor of claim 24; and
a case encircling the rotor and having:
a substrate; and
a coating on an inner surface of the substrate facing the rotor.

26. A method for using the blade of claim 19, the method comprising:
causing the tip coating to abrade an adjacent coating.

27. A blade comprising:
an airfoil (100) having:
a root end and a tip (106);
a metallic substrate (102) along at least a portion of the airfoil; and
a tip coating (152) comprising an abrasive (156) and an aluminum-based matrix (154), the aluminum-based matrix comprising, by weight:
1.0-7.50 percent Zn.

28. The blade of claim 27 wherein the matrix comprises, by weight:
0.010-0.030 percent In.

29. The blade of claim 27 wherein the aluminum-based matrix comprises by weight one to all of:
0.05-0.20 Si; and
0.010-0.40 percent combined one-to all of In, Sn, Cd, Ga, Hg.

30. The blade of claim 27 wherein:
the matrix comprises, by weight:
balance Al;
4.75-5.75 percent Zn;
0.016-0.020 percent In;
0.20 max. each other element; and
0.50 max. total other elements.

31. A blade comprising:
an airfoil (100) having:
a root end and a tip (106);
a metallic substrate (102) along at least a portion of the airfoil; and
a tip coating (152) comprising an abrasive (156) and an aluminum-based matrix (154), the aluminum-based matrix being at least 275 millivolts more active than the metallic substrate.

32. The blade of claim 31 wherein:
the metallic substrate is aluminum-based.
